(19) United States
(12) Patent Application Publication
(10) Pub. No.: US 2021/0227959 A1
(43) Pub. Date: Jul. 29, 2021

(54) CASE FOR TOOL

(71) Applicant: West Coast Chain Mfg. Co., Ontario, CA (US)

(72) Inventors: Edward J. Rodriguez, Jr., Fontana, CA (US); Edwin S. Fung, Walnut, CA (US); Jesus Flores, Moreno Valley, CA (US)

(21) Appl. No.: 17/053,526

(22) PCT Filed: May 6, 2018
(86) PCT No.: PCT/US18/31282

§ 371 Date: Nov. 6, 2020

(51) Int. Cl. A45F 5/02; G01B 3/1071

(52) U.S. Cl. CPC A45F 5/021; A45F 2005/006; G01B 3/1071

(57) ABSTRACT

A tool case includes a pocket for holding a tool. The pocket is defined by a shell, a first interconnecting piece and a second interconnecting piece. The shell includes a flat bottom and a first and second side that extend upwards from opposite sides of the flat bottom. The shell also includes a closable rear access opening. The first interconnecting piece connects a first side of the shell with a second side of the shell at a top of the shell. The second interconnecting piece connects the first side of the shell with the second side of the shell at a front of the shell. A fastener is configured to releasably couple the first side and the second side at the closable rear opening, in a manner that reduces twisting of the case when dangling from a tether.

### BACKGROUND

### 1. Field

Some embodiments of the present disclosure relate generally to tool safety equipment.

### 2. Description of the Related Art

The construction of high-rise buildings and tall structures poses a particular risk when workers use tools from great heights above the ground. A tool dropped from an upper floor of a high-rise building could result in serious injury or death if the dropped tool were to strike a person. Fall protection violations, including dropped tools, continue to rank high on OHSA's list of violations. In fact, there are more than 50,000 “struck by falling object” OSHA recordables every year in the United States, alone. That is about the equivalent of one injury from a dropped object every 10 minutes.

Unsecured items that can cause serious injury range from heavier hand-tools, such as hammers, to lighter hand-tools, such as tape measures. In fact, a man making a delivery to a construction site in New Jersey was killed by a one-pound tape measure dropped by a worker from 50 stories above. Not only do dropped tools pose a risk to the people below, the person who dropped the tool is also at risk, as his first reaction may be to reach for the falling object which may cause him to lose his balance.

Debris nets, toe boards and helmets help but they have their limitations. Effectiveness of debris nets depends on the net hole dimensions, that is, smaller objects can fall through. Toe boards protect only the workers immediately below and can also pose trip hazards for workers. More importantly, both of these safety measures have to withstand considerable force—an eight-pound wrench dropped 200 feet would hit with a force of 2,833 pounds per square inch. A better solution would be to prevent the drop in the first place.

Tethering the tool or equipment to the user is known. However, any drop prevention measure should minimize interference with the normal use or function of the tool or equipment being tethered. Moreover, any tether, straps or case should be readily adjustable and adapted for use with tools that vary to some degree in size, weight and/or configuration. Furthermore, any fasteners that are used to retain the tool should tolerate repeated use without excessive wear and tear and/or decrease in effectiveness. Selected fasteners, such as of the hook and loop type, are effective at the outset, but over time they tend to collect dirt, hair and other debris which reduce their hold performance.

An easy-to-use tethered case is therefore needed that can accommodate a variety of tools, where such case is readily adjustable and adapted for use with multiple tools and equipment that vary to some degree in size, weight and/or configuration. The case should not interfere with the normal use of the tool and any fasteners provided on the case should allow for repeated use without excessive wear and tear and/or decrease in effectiveness.

The above information is only for enhancement of understanding of the background of embodiments of the present disclosure, and therefore may contain information that does not form the prior art.

### SUMMARY

Some embodiments of the present disclosure provide a case for a tool comprising a pocket defined by a shell, at least one interconnecting member, and a tether, wherein the shell comprises a bottom portion, a first side portion and a second side portion extending upwards from the bottom portion, and a rear opening spanning between extended rear portions of the first and second sides portions, the at least one interconnecting member extends between the first and second side portions of the shell; and the tether has a fastener configured to releasably couple the first and second extended rear portions in closing the rear opening.

In some embodiments, each of the extended rear portions has a through-hole and the fastener is configured to be inserted through each through-hole.

In some embodiments, a first opening is defined between the at least one interconnecting member and a front edge of the bottom portion.

In some embodiments, the case includes a second interconnecting member extending between the first and second side portions of the shell.

In some embodiments, a second opening is defined between the second interconnecting member and the first interconnecting member.

In some embodiments, the shell includes a respective grommet in each through-hole.

In some embodiments, the first side portion includes a through-hole.

In some embodiments, the shell includes a first material of lesser elasticity and a second material of greater elasticity.

In some embodiments, at least one of the side portions includes a first material of lesser elasticity and a second material of greater elasticity.

In some embodiments, a tool case includes a shell having U-shaped cross-section defined by first and second opposing side portions connected at their lower edges by a base portion. The first opposing side portion has a first extended rear portion, the second opposing side portion has a second extended rear portion, the first extended rear portion has a first through-hole, and the second extended rear portion has a second through-hole. The case also includes a tether having a tensile member with a first fastener at a first end of the tensile member and a second fastener at a second end of the tensile member, where the first fastener is configured to pass through the first and second through-holes.

In some embodiments, the shell includes a band extending between the first and second side portions at their front edges.

In some embodiments, the shell includes a band extending between the first and second side portions at their top edges.

In some embodiments, the shell is constructed from a single piece of material that includes the first and second side portions and the base portions.

In some embodiments, the first side portion includes two pieces of a first material.

In some embodiments, the first side portion includes a third piece of a second material.

In some embodiments, the first material has lesser elasticity and the second material has greater elasticity.

In some embodiments, the shell has a longitudinal center seam in the bottom portion.

In some embodiments, the shell has a longitudinal seam in one of the side portions.

In some embodiments, the shell includes a first material of a lesser elasticity and the longitudinal seam includes a second material of a greater elasticity.

In some embodiments, a side portion includes a window.

In some embodiments, a tool case has a shell having U-shaped cross-section defined by first and second opposing side portions connected at their lower edges by a base portion. The first opposing side portion has a first extended rear portion, the second opposing side portion has a second extended rear portion, the first extended rear portion has a first through-hole, and the second extended rear portion has a second through-hole. The tool also includes a tether having a tensile member with a fastener at a first end of the tensile member, the fastener being configured to pass through the first and second through-holes. Advantageously, each of the first and second extended rear portions has a width dimension such that the first and second extended rear portions are in a parallel planar configuration, and the fastener when coupling the first and second through-holes is configured to generally maintain the first and second extended rear portions in the parallel planar configuration.

### BRIEF DESCRIPTION OF THE DRAWINGS

Some embodiments can be understood in more detail from the following description taken in conjunction with the accompanying drawings, in which:

FIG. 1A depicts a case for a tool from a front perspective according to various embodiments of the present invention;

FIG. 1B depicts the case for a tool from a rear perspective according to various embodiments of the present invention;

FIG. 2 depicts a front perspective view of sample tool, namely, a tape measure;

FIG. 3 depicts a front view of the case of FIG. 1;

FIG. 4 depicts a rear view of the case of FIG. 1;

FIG. 5 depicts a bottom view of the case of FIG. 1;

FIG. 6A, FIG. 6B and FIG. 6C depict pieces for construction of a case according to various embodiments of the present invention; and

FIG. 7A and FIG. 7B depict pieces for construction of a case according to various other embodiments of the present invention.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof will not be repeated. The drawings are not necessarily to scale and the relative sizes of elements, layers, and regions shown may be exaggerated for clarity.

Embodiments of the present disclosure include a case for a tool for use with a safety tether that is attachable to a person, device and/or structure. In various embodiments, the case is configured for use with a tape measure. The case is configured to allow easy deposit and removal of the tape measure in and out of the caseand to securely retain the tape measure in the case, but the case also includes various elements to allow for the normal, uninhibited and/or unobstructed use of the tape measure and any additional features of the tape measure while it is securely inside the case.

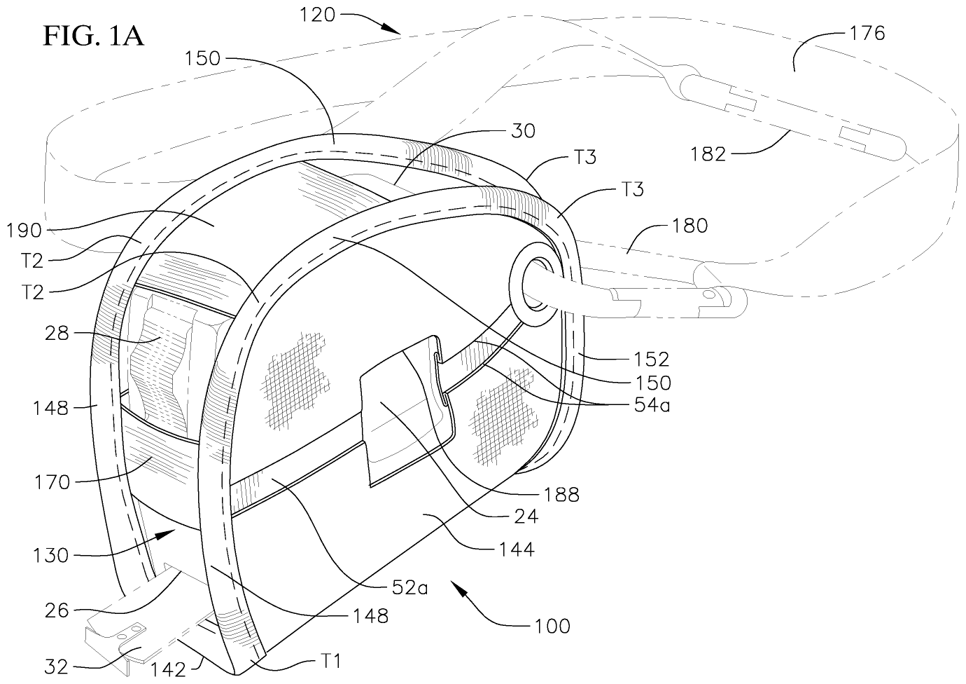

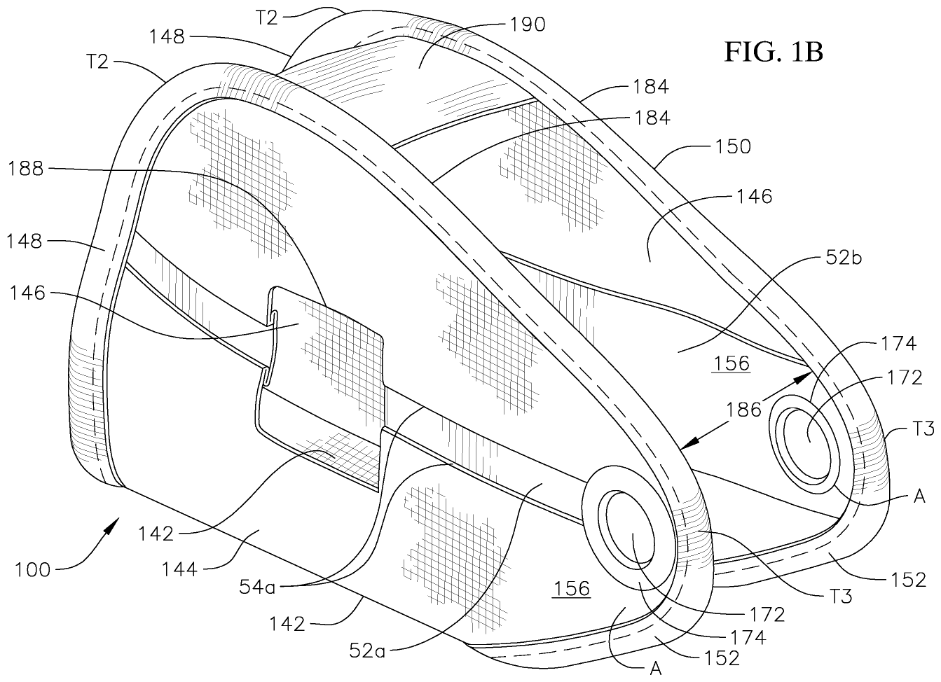

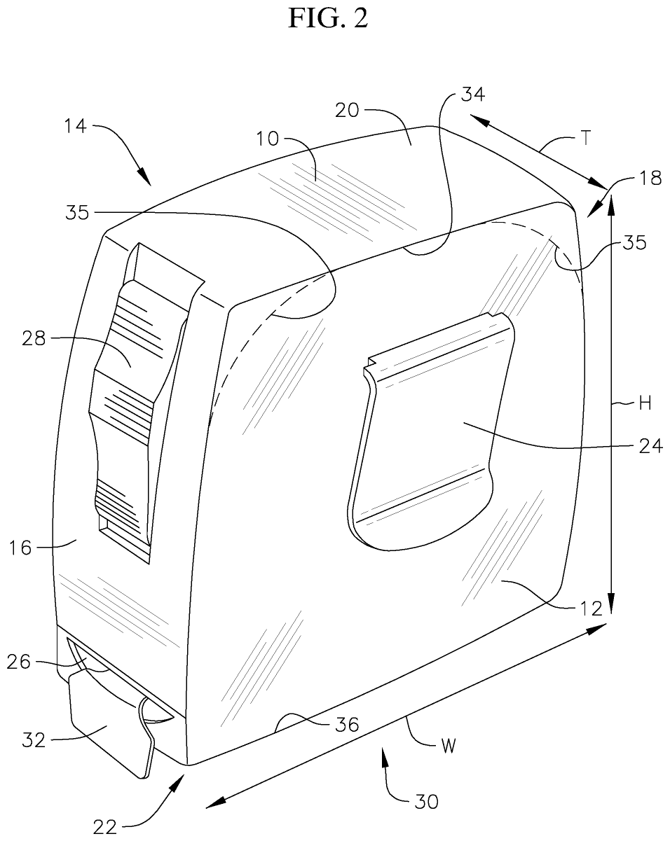

FIG. 1A, FIG. 1B and FIG. 2 depict a case 100 for a tool according to various embodiments of the present invention. In various embodiments, the case 100 may be configured to substantially surround and hold a tool such as a tape measure 30 in a pocket 130. In various embodiments, the case 100 may be configured to attach to a safety tether 120 in a configuration where the case has advantageous characteristics and functions, including reliably retaining the tool inside the case, enabling normal use of the tool while inside the case, preventing the tool from falling when dropped, and hanging in a secured orientation with dampened swing or twisting.

In various embodiments, the case 100 includes a shell 140 having a U-shaped cross-section that defines the pocket 130. In various embodiments the shell 140 may be constructed out of a first material that is durable yet flexible, such as a canvas, however, in various embodiments, the shell 140 may include at least a second material that has greater flexibility and/or elasticity relative to the first material, which occupy strategic, predetermined regions of the case 100. In various embodiments, the shell 140 is shaped and/or sized to accommodate the tool in the pocket 130 with a close fit. For example, in various embodiments, the tool may be a tape measure 30 and the shell 140 may be shaped and/or sized accordingly. As shown in FIG. 2, many tape measures 30 often have a housing 10 shaped somewhat in a block form, with a thickness T, height H and width W. The housing 10 of the tape measure 30 includes first and second side surfaces 12 and 14 (14 not shown), front and rear surfaces 16 and 18 (18 not shown), and upper and lower surfaces 20 and 22 (22 not shown), where the tape measure can often stand on its lower surface 22 on a flat support surface. The housing 10 includes an opening 26 formed in the front surface 16 through which a measuring tape 32 wounded on a retractable reel (not shown) passes and can be drawn and extended from the housing 10 by a user. The housing 10 may also include a lock mechanism or button 28 on the front surface 16 for a user to releasable lock rotation of the retractable reel that is contained in the housing. The housing 10 also often includes a belt clip 24 provided on the first side surface 12. Upper edges 34 of the side surfaces 12, 14 may be generally straight, or they may be curved (see broken lines 35) in conformity with the circular outline of the retractable reel Lower edges 36 of the side surfaces 12, 14 are straight as the lower surface 22 of the tape measure is flat so that the tape measure 30 can stand on a flat surface. Thus, the shell 140 of the case 100, as shown in FIG. 1A and FIG. 1B, may include a flat bottom with sides configured to accommodate the tape measure 30, wherein the case 100 holding the tape measure 30 can stand on its flat bottom. Depending on the material(s) of the case 100, the case may also be able to stand on its flat bottom without the tape measure 30.

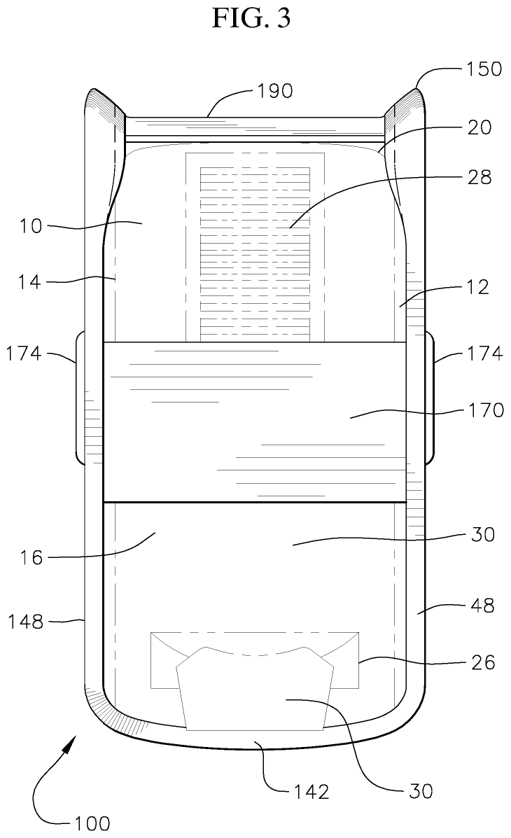

With reference to FIG. 2 and FIG. 3, in various embodiments, the shell 140 may resemble a “taco-shell,” having a U-shaped cross section, including a base or bottom portion 142 and first and second side portions 144, 146 extending generally perpendicularly or upwardly from the bottom portion 142. The first and second side portions 144, 146 define a space gap in between which includes the pocket 130, and the first and second side portions 144, 146 may be deformed from their generally-planar neutral configuration so as to be separated or spread apart from each other by a user to gain wider access into the pocket 130. In some embodiments, the case 100 is configured so that when the tape measure 30 is received in the pocket 130 an inner surface of the bottom portion 142 of the shell faces or is in contact with the lower surface 22 of the tape measure 30, and inner surfaces of the side portions 144, 146 of the shell face or are in contact with the side surfaces 12, 14, respectively.

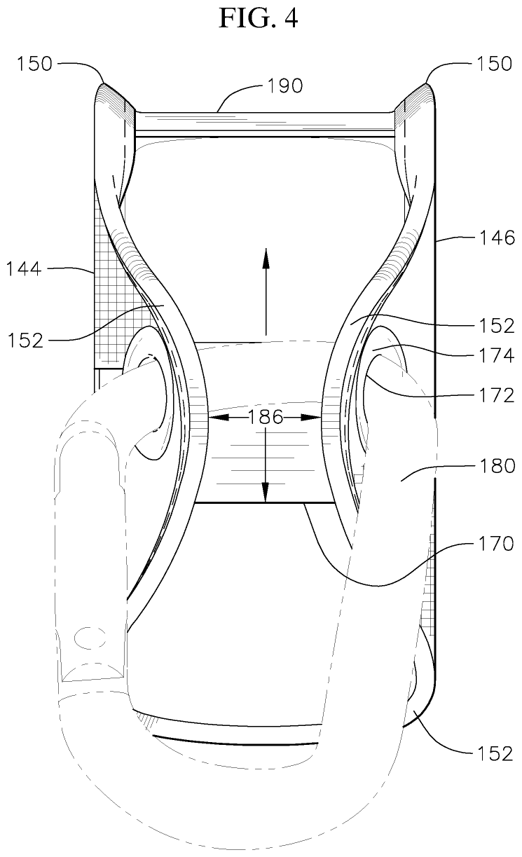

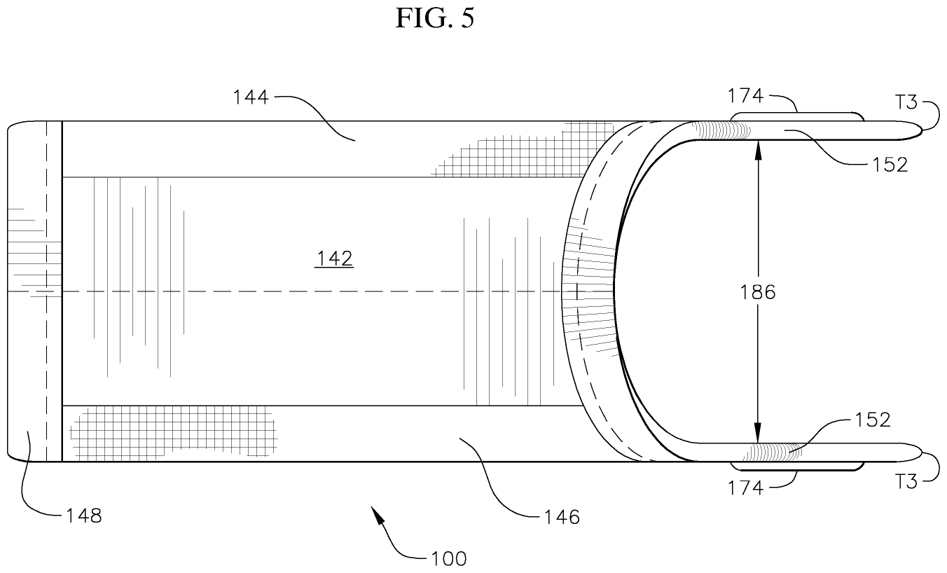

With reference to. FIG. 4, in various embodiments, the side portions 144, 146 of the shell 140 of the case 100 are generally mirror-images of each other, each defining a front edge 148, a top edge 150, a rear edge 152 and a bottom edge 154. In various embodiments, the bottom edge 154, with a length L4, is generally straight so as to provide the relatively flat bottom portion 142 to accommodate the flat lower surface 22 of the tape measure 30. At transition T1, the front edge 148 is generally perpendicular to the bottom edge 154 and has a mild curvature with an arcuate length L1 that tapers as it approaches transition T2 with the top edge 150. The top edge 150 is somewhat parallel to the bottom edge 154 and also has a mild curvature with an arcuate length L2 that tapers as it approaches transition T3 with the rear edge 152. The rear edge 152 has a generally straight length L3 which extends diagonally toward transition T4 with the bottom edge 154. In some embodiments, the lengths L1, L2, L3 and L4 are defined by the relationship:

L3<L4<L1<L2 (Eqn. 1)

with each side portion 144, 146 having an extended rear portion 156 (e.g., generally triangular configuration) tapering to an apex A at or near the transition T3 that lies on or near a mid-center line C of the maximum distance D between the bottom edge 154 and the top edge 150. Thus, in some embodiments, the profile of each side portion 144, 146 (146 not shown in FIG. 4) mimics and generally conforms to the shape of the tool (e.g. the tape measure 30) except for the extended rear portion 156, the significance of which is discussed further below.

In various embodiments, one or more of the edges 148, 150, 152 may include a protective reinforcement or edging 184 to improve the durability of the edges. For example, in various embodiments, one or more of the front, top and rear edges 148, 150, 152 may include one or more layers of material, for example, material that is identical or similar to the first material of the shell 140 or a different material, where these one or more layer cover the edges and are securely affixed to the edges, for example, by stitching or adhesive.

In various embodiments, the shell 140 may have a relatively flat and rectangular bottom portion 142 that connects to or is contiguous with each side portion 144, 146 along its bottom edge 154. Each bottom edge 154 may be relatively linear in shape extending from a front edge 148 of the shell 140 to the rear edge 152 of the shell 140. In various embodiments, the two side portions 144, 146 may be connected by one or more interconnecting members 170, 190 that traverse the space gap and extend between the side portions 144, 146, spanning across the tool, for example, across the front surface 16 and/or the upper surface 20 of the tape measure 30. The first interconnecting member 170 is strategically positioned or affixed at a predetermined location at or near the front edges 148 of the side portions 144, 146 so that the opening 26 in the front surface 16 of the tape measure 30 is unobstructed and the measuring tape 32 can be dispensed and retracted in its normal operation without inference by the member 170. The second interconnecting member 190 is strategically positioned or affixed at a predetermined location at or near the top edges 150 of the side edges 144, 146 so that the locking mechanism 28 on the front surface 16 of the tape measure 30 is unobstructed and can be actuated in its normal operation without interference by the member 190. Notably, a rear access opening 186 of the case 100 (see FIG. 1B), in the space gap primarily between the extended rear portions 156, is generally free of any interconnecting members, which allows for easy ingress and egress of the tool (e.g., measuring tape 32) into the inner pocket 130 of the case 100.

In some embodiments, the interconnecting members 170, 190 include strips or bands of a material with greater elasticity than the first material used in the construction of the shell 140, so as to accommodate tools of slightly different shapes and sizes. Suitable materials include, for example, elastic bands or elastic webbing. In various embodiments, the interconnecting members 170, 190 are sized and positioned to maintain the tool in the pocket 130, while allowing user access to one or more tool features, including, for example, the measuring tape 32 and the lock mechanism 28. In various embodiments, the interconnecting members 170, 190 have an elastic stretch length that allows a span between the side portions 144, 146 that is about equal to or less than the thickness T of the tool or measuring tape 30.

In various embodiments, a through-hole 172 is provided near the apex A in the extended rear portion 156 of each side portion 144, 146. Each through-hole 172 may be reinforced by a grommet 174 or any other suitable hole reinforcement, e.g., stitching, sealant, application of heat for thermoplastic melting, etc. Each through-hole 172 is configured to receive the safety tether 120, which may include a cord or lanyard 176 with a releasable fastener 180, e.g., a carabiner, that is configured to releasably coupled the extended rear portions 156 via the through-holes 172. The through-holes 172 allow the extended rear portions 156 of both side portions 144,146 to be drawn toward each other, thus reliably trapping the tool inside the pocket 130 of the case 100, particularly where the case containing the tool is hanging freely under the force of gravity so that the extended rear portions 156 are at higher elevation than the rest of the case 100. In that regard, the extended rear portions 156 serve to support the weight of the case 100 with the tool 110 (e.g., the tape measure 30), where each extended rear portion has a planar width WW and is generally parallel to each other (see FIG. 4), in a manner that helps stabilize and/or dampen excessive swing or twisting motion of the case 100 and the tool when they are coupled to and hanging by the safety tether 120. It is understood that the extended rear portions may be any suitable shape that provides a planar width WW that tapers to the apex A so that the shell has a generally continuous transition between the side portions 144,146 and the apex A. In various embodiments, the fastener 180 is configured to draw together the extended rear portions 156 at the apex A, keeping them generally parallel with each other, thereby generally closing the pocket 130 and securing the tool 110 therein, wherein the fastener 180 minimizes the ability of the extended rear portions 156 to shift laterally. With minimized ability to shift laterally, the extended rear portions 156 help stabilize the case by helping to keep the case from twisting when hanging from the safety tether 120.

In various embodiments, the safety tether 120 may include one or more ties, a zipper, a clip, a carabiner, one or more buttons or snaps, or any other detachable fastener, including hook and loop fasteners. The extended rear portions 156 may also include other fasteners, e.g., snap, button, clip and hook and loop fasteners for additional or secondary security. While the illustrated embodiments include two through-holes 172, one in each side portion 144, 146, other embodiments may include a single through-hole 172 (for attachment to the safety tether 120) in combination with any of the aforementioned fasteners in or near the extended rear portions 144, 146, including those fasteners that will help keep the extended rear portions parallel to each other.

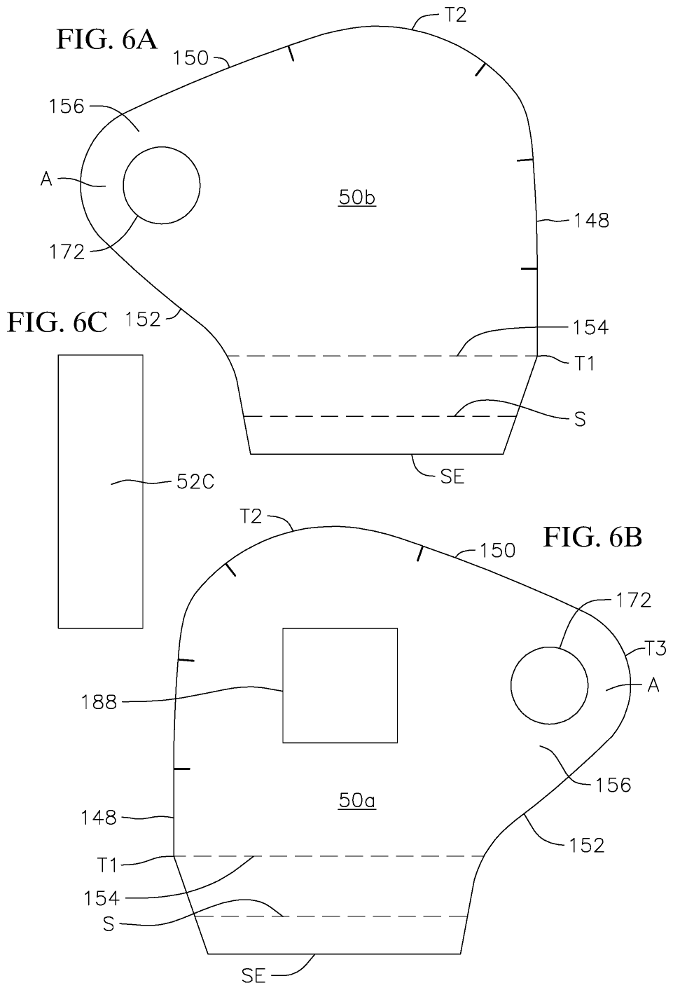

The shell 140 may be constructed from a single piece of the first material with “fold” lines delineating the bottom edges 154 of the bottom portion 142. Alternatively, the shell 140 may be constructed from a combination of multiple pieces of material(s) affixed together by any suitable means, including stitching. As shown in FIG. 6A and FIG. 6B, the shell may be constructed from at least first and second pieces 50a and 50b which are generally mirror images of each other. Straight edges SE are affixed together which result in a seam S that is generally a longitudinal centerline of the bottom portion 142 of the shell. Each of the first and second pieces 50a and 50b forms a respective side portion 144 and 146 and about half of the bottom portion 142. Piece 50a is configured with a window 188 providing access to the belt clip 24 on the tape measure 30. In some embodiments, as shown in FIG. 1A, FIG. 1B and FIG. 6C, extension pieces 52a, 52b, 52c of a second material (e.g., with greater elasticity and/or flexibility relative to the first material) are inserted at cut lines 54a, 54b and S, respectively, and affixed to the piece(s) 50a and/or 50b to provide more elasticity and/or flexibility to the shell 140.

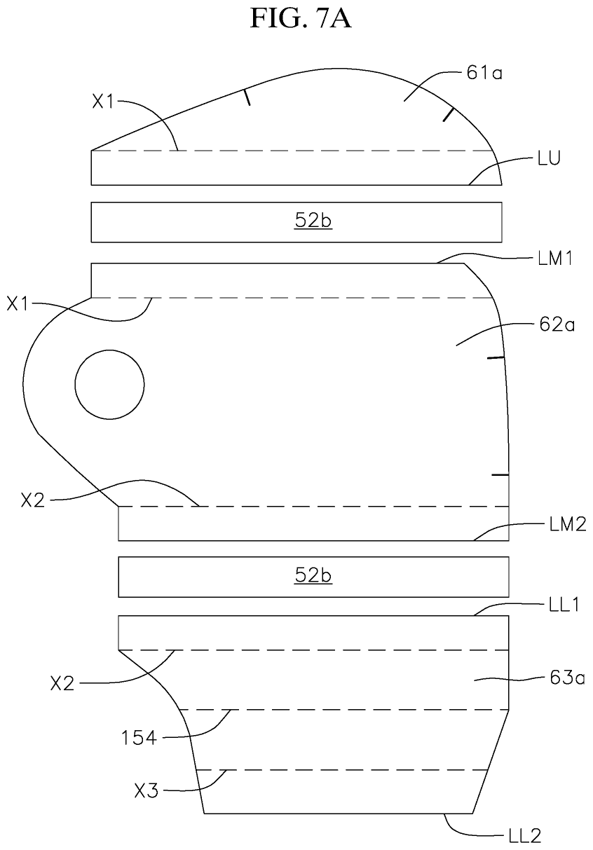

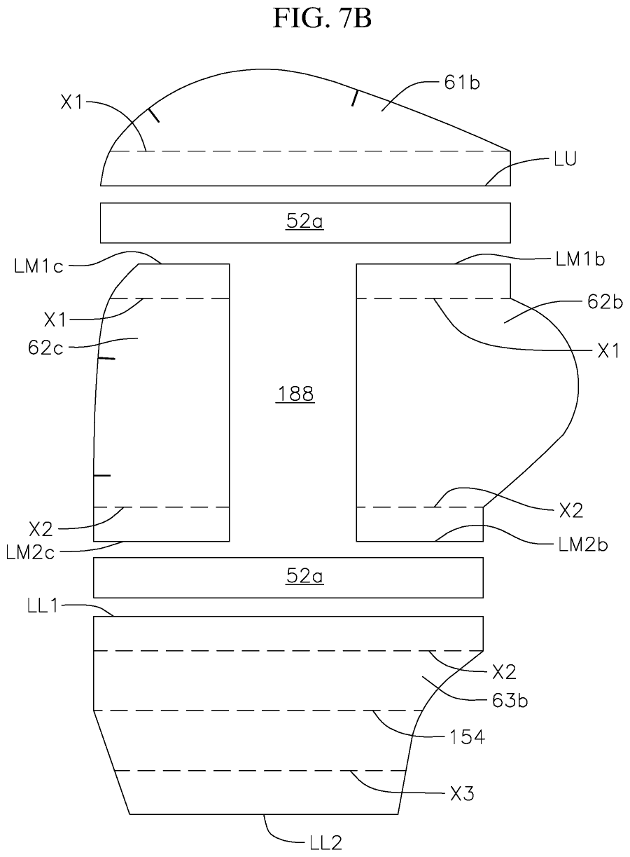

Further alternatively, as shown in FIG. 7A and FIG. 7B, the shell 140 may be constructed from multiple pieces, including upper pieces 61a, 61b, mid pieces 62a, 62b, 62c and lower pieces 63a, 63b. With reference to FIG. 7A, the pieces 61a, 62a and 63a have their respective generally linear borders LU, LM1, LM2 and LL1 wherein the border LU of the piece 61a and the border LM1 of the piece 62a are configured for affixation with each other along affixation line X1, and the border LM2 of the piece 62a and the border LL1 of the piece 63a are configured for affixation with each other along affixation line X2 to form a composite piece 65a having the pieces 61a, 62a and 63a. With reference to FIG. 7B, the pieces 61b, 62b, 62c and 63b have their respective generally linear borders LU, LM1b, LM1c, LM2b, LM2c and LL1, wherein the border LU of the piece 61b and the borders LM1b of the piece 62b and the border LM1c of the piece 62c are configured for affixation with each other long affixation line X1, and the border LM2b of the piece 62b and the border LM2c of the piece 62c are configured for affixation with the border LL1 of the piece 63b along affixation line X2 to form a composite piece 65b. Notably, the pieces 62b and 62c are sized relative to the pieces 61b and 63b so as to form the window 188 in the shell. So formed, the composite pieces 65a and 65b are generally mirror-images of each other (with the exception of the window 188) and may be affixed to each other along their respective borders LL2 to form a shell 140. In some embodiments, extension pieces 52a and 52b of a second material may be inserted between any two borders to provide greater elasticity and/or flexibility to the shell.

Thus, in some embodiments, the shell includes a bottom portion 142 and two opposing side portions 144, 146 defining a pocket therebetween configured to receive the tool that can be deposited into the pocket via a rear access opening 186 spanning between the two opposing extended rear portions 156 of the shell and is retained within the pocket of the shell by the interconnecting members 170, 190 extending between the side portions 144, 146 and releasable closure of the rear access opening 186 by a fastener 180 of a safety tether 120 that is configured to secure the case 100 and the tool to a user's person, a device and/or a structure. The shell may have a variety of construction from multiple pieces of materials, including elastic portions, to provide more flexibility and elasticity.

In use, the extended rear portions 156 of the case 100 are separated from each other by a user to widen the rear access opening 186 into the pocket 130. The user deposits the tool (e.g., the tape measure 30) into the pocket 130, with the lower surface 22 of the housing 10 of the tool facing an inner surface of the bottom portion 142 of the case 100 and the front surface 16 of the housing facing the front edges 148 of the side portions 144,146 of the case 100. Where the tool is a tape measure 30, its opening 26 is situated in the gap between the bottom portion 142 and the interconnecting member 170, and the locking mechanism 28 is situated in the gap between the interconnecting members 170 and 190. As such, both the measuring tape 32 and the locking mechanism 28 are exposed and readily accessible to the user while the tape measure 10 is held in the case 100. The interconnecting member 170 is in general contact with the front surface 16 of the housing 10 of the tool, and the interconnecting member 190 is in general contact with the upper surface 20 of the housing of the tool. The user then draws the extended rear portions 156 together and engages or clips the fastener 180 (e.g., carabiner) of the safety tether 120 through both through-holes 172. The safety tether at its other end is attached to the user's person, a device and/or a structure by a second fastener 182, for example, a second carabiner, which prevents the tool and the case from accidentally dropping to a significantly lower elevation. Where the second fastener 182 is attached to the user's body, the user may wear the tape measure 30 with the case 100 on his body by fastening the belt clip 24 (exposed via the window 188 in the shell) onto his belt or pants waist band. In the event the belt clip 24 becomes dislodged from the user's belt or pants waist band, the tape measure 30 will be securely tethered to the person's body by the case 100 and the safety tether 120. Whether the case 100 containing the tool are purposefully dangling from a user's body, a device or a structure, or whether the case 100 containing the tool has been accidentally dislodged from a user's belt or waistband, the free-hanging case 100 holding the tool can dangle with less swing and/or twisting under the force of gravity because of the width WW of each extended rear portions 156 and the side-by-side or parallel double-coupling of the fastener 180 through both through-holes 172. Notably, the location of through-holes 172 and thus attachment of the safety tether 120 to the case 100 are remote and opposite of the opening 26 of the measuring tape 30 and the locking mechanism 28 so the user can readily extend the measuring tape 32 and actuate the locking mechanism 28. Moreover, the weight of the tool itself maintains the case 100 in a retention orientation where the rear access opening 186 is facing upwardly and the tool is weighted downwardly away from the rear access opening 186 and the fastener 180. After use, the tool or tape measure 30 may be removed from the case 100 by the user decoupling the fastener 180 from the through-holes 127, separating the extended rear portions 156 and lifting or otherwise removing the tool or tape measure 30 from the pocket 130 of the case 100.

In the preceding description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

1.-21. (canceled)

22. A tool case comprising:
a shell having a bottom portion, a first side portion and a second side portion extending upwardly from the bottom portion, the first side portion having a first main portion and a first extended rear portion and the second side portion having a second main portion and a second extended rear portion, the first and second extended rear portions being generally triangular and defining a rear opening therebetween, the first extended rear portion having a first through-hole, the second extended rear portion having a second through-hole; and
an interconnecting member extends between the first and second side portions of the shell,
wherein the shell is configured to hang under force of gravity via the first and second through-holes, with the first and second extended rear portions at a higher elevation than the first and second main portions.

23. The tool case of claim 22 wherein the first extended rear portion has a first apex and the second extended rear portion has a second apex.

24. The tool case of claim 22, wherein the bottom portion has a rear edge and the first and second extended rear portions extend past the rear edge of the bottom portion.

25. The tool case of claim 22, further comprising a fastener configured to extend through the first and second through-holes in traversing the rear opening to releasably couple the first and second extended rear portions.

26. The tool case of claim 25, further comprising a tether connected to the fastener.

27. The tool case of claim 22, wherein the bottom portion has a front edge, and a first opening is defined between the interconnecting member and the front edge of the bottom portion.

28. The tool case of claim 22, further comprising a second interconnecting member that extends between the first and second side portions of the shell.

29. The tool case of claim 28, wherein a second opening is defined between the second interconnecting member and the first interconnecting member.

30. The tool case of claim 22, wherein the shell includes a first grommet in the first through-hole and a second grommet in the second through-hole.

31. The tool case of claim 23, wherein the first through-hole is adjacent the first apex and the second through-hole is adjacent the second apex.

32. The tool case of claim 22, wherein the first side portion includes a first interconnecting strip.

33. The tool case of claim 22, wherein the shell includes one material of lesser elasticity and another material of greater elasticity.

34. The tool case of claim 22, wherein the first side portion includes one material of lesser elasticity and another material of greater elasticity.

35. The tool case of claim 22, wherein the first side portion has a first front edge and a first top edge, the second side portion has a second front edge and a second top edge, the interconnecting member extends between the first front edge and the second front edge, and a second interconnecting member extends between the first top edge and the second top edge.

36. The tool case of claim 35, wherein each interconnecting member includes an elastic material.
